(19) United States
(12) Patent Application Publication
(10) Pub. No.: US 2008/0216652 A1
(43) Pub. Date: Sep. 11, 2008

(54) PROCESS AND DEVICE FOR SEPARATING HYDROGEN FROM GAS FLOWS HAVING AN OXYGEN CONSTITUENT

(75) Inventors: Tobias KELLER, Feldkirchen-Westerham (DE); Paul LEITGEB, Pullach (DE); Werner LEITMAYR, Neuburg/Donau (DE); Ulrike WENNING, Pullach (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Munich (DE)

(21) Appl. No.: 12/043,042

(22) Filed: Mar. 5, 2008

(30) Foreign Application Priority Data
Mar. 6, 2007 (DE) 10 2007 010 875.5

(51) Int. Cl. B01D 53/047; B01D 53/02

(52) U.S. Cl. 95/96; 96/154

(57) ABSTRACT

A process and a device for separating hydrogen from a gas flow having an oxygen constituent, comprised primarily of hydrogen, nitrogen, oxygen, carbon dioxide, carbon monoxide, methane and/or other hydrocarbons, is disclosed. The gas flow is compressed in a multi-stage compression process and then cooled to room temperature by a heat exchanger. After a pre-adsorber, the gas flow is fed to a catalytic process for removing the oxygen. The catalytic reaction for removing the oxygen takes place exothermically. The gas flow is then cooled to room temperature via another heat exchanger and fed to a pressure swing adsorption process for hydrogen separation. The hydrogen is separated there from the residual gas.

This application claims the priority of German Patent Document No. 10 2007 010 875.5, filed Mar. 6, 2007, the disclosure of which is expressly incorporated by reference herein.

### BACKGROUND AND SUMMARY OF THE INVENTION

The invention relates to a process for separating hydrogen from a gas flow having an oxygen constituent, comprised primarily of hydrogen, nitrogen, oxygen, carbon dioxide, carbon monoxide, methane and/or other hydrocarbons, as well as a device for performing the process.

The invention is described using the example of separating hydrogen from coke oven gas, but is suitable for separating hydrogen from any gas flow of any composition of the above-mentioned components and is therefore not limited to coke oven gas.

When coke is manufactured in coking plants, for the most part bituminous coal is heated with the exclusion of air. Coke, coke oven gas and tar are generated in the process. The more carbonaceous coke is used mainly in the production of iron. The coke oven gas comprised predominantly of hydrogen, methane and carbon monoxide is used mainly as an industrial fuel according to the prior art. However, coke oven gas has only about half the heating value of natural gas and is frequently contaminated by accompanying substances, which can cause the emission of toxic substances or operating malfunctions. As a result, because of stricter environmental guidelines, efforts are being made to find alternative uses for coke oven gas.

Coke oven gas is often comprised of approx. 60% hydrogen. Among other things, hydrogen is required in large quantities in oil refineries to reduce the sulfur content of middle distillates in so-called hydrotreaters and to breakdown different crude oil fractions in so-called hydrocrackers. In addition, hydrogen is used in the reduction of metal oxides, the manufacturing of ammonia, as a propellant, or in fuel cells. European Patent Document No. EP 1033346 describes a prior art process for separating hydrogen from a gas flow, which, in addition to hydrogen, contains predominantly nitrogen, carbon dioxide, carbon monoxide and methane along with the impurities of oxygen and argon.

In the case of a process for pressure swing adsorption according to the prior art, the gas mixture is fed under high pressure to a reactor having an adsorber. Depending upon the prevailing pressure and the adsorber material, the components of the gas mixture are adsorbed by the adsorber material at different intensities. In an ideal case, all components of the gas mixture are adsorbed by the adsorber with the exception of hydrogen. Hydrogen is thus separated from the remaining components with a high level of purity. Regeneration of the adsorber takes place at low pressure by desorption of the bound components, which can then also be withdrawn in a gaseous manner from the reactor. Thus, hydrogen having a high level of purity can be separated from the remaining gaseous components using a pressure swing adsorption process with the use of several reactors, which adsorb and/or desorb in an alternating manner. By using the process described in EP 1033346, hydrogen with a purity of a maximum of 99.99% can be separated from the remaining gaseous components.

An increased safety risk arises with the use of this type of process according to the prior art in the case of oxygen constituents in the gas flow of greater than 1% by volume. The oxygen present in the gas mixture is adsorbed to begin with at high pressure in the adsorber, but in the subsequent progression is again displaced into the gas phase by components that are being adsorbed more powerfully. This produces oxygen enrichment in the adsorber so that an ignitable, explosive mixture is produced in combination with the hydrogen present in the gas. This explosive mixture represents a safety risk in a pressure swing adsorption process according to the prior art.

The present invention is therefore based on the objective of devising a process of the type mentioned at the outset that avoids the formation of an explosive hydrogen-oxygen gas mixture and minimizes the safety risk of this type of process.

The objective at hand is attained in that a catalytic process for removing the oxygen is combined with a pressure swing adsorption process for separating hydrogen, wherein the pressure swing adsorption process is performed after the catalytic process for removing the oxygen.

By combining a catalytic process for removing the oxygen with a pressure swing adsorption process, the oxygen content in the gas mixture is already minimized before the pressure swing adsorption process in such a way that an explosive gas mixture of hydrogen and oxygen cannot arise. The first studies show that despite the high proportion of catalytic poisons, the oxygen can be transformed catalytically very selectively. Surprisingly and contrary to the previous state of the art, the catalytic activity is not negatively impacted by the catalytic poisons present in the gas flow. In the case of the catalytic reaction, no appreciable amounts of either methane or ammonia are formed. In addition, it has been shown that when using the inventive process a catalytic subsequent cleaning of the separated hydrogen can be dispensed with in most cases. The depletion of the oxygen for safety reasons and depletion to achieve the required product purity thus take place in a single step.

Through the use of the inventive process, gas flows having an oxygen constituent of greater than 1% by volume are also advantageously processed safely by the pressure swing adsorption process.

Conventional hydrogenating and oxidizing catalysts are preferably used as catalysts. Precious metals, in particular platinum and/or palladium on a solid supporting material, in particular aluminum oxide and/or ceramic in a spherical or honeycomb shape, are preferably used as catalyst materials. The advantage of precious metals that are used individually or in combination on various supporting materials is that they are commercially available and have an economically expedient service life. A very selective catalytic transformation of the oxygen is also achieved with the catalyst materials used.

After the catalytic process for removing the oxygen, the gas flow is advantageously fed via a compression process, at least a heat exchanger and/or a pre-adsorber to the pressure swing adsorption process. According to the prior art, the gas flow is compressed in a compression process, cooled and fed via a pre-adsorber for removal of polymolecular hydrocarbons as starting material to a pressure swing adsorption process for separating the hydrogen. Several possibilities emerge, depending upon the embodiment of the invention, for the inventive positioning of the catalytic process for removing the oxygen before the pressure swing adsorption process.

In one embodiment of the invention, the catalytic process for removing the oxygen is positioned with a downstream heat exchanger before the compression process. In this embodiment of the invention, the catalytic process can be performed with relatively low pressure of the gas flow (approx. 2 bar) as well as at relatively low temperatures (approximately room temperature). In this case, the relatively low pressure above all has a favorable effect on the service life of the catalyst.

In another embodiment of the invention, the catalytic process for removing the oxygen is performed after the compression process. In this embodiment of the invention, the catalytic removal of oxygen takes place in fact at a relatively high gas pressure (approx. 8 bar) but also at a high temperature (approx. 400° C.). The high temperature in particular has a positive effect on the service life of the catalyst. Specifically, a catalyst made of platinum on ceramic honeycombs can be regenerated already at temperatures of 400° C., i.e., the presumed catalytic poisons such as carbon monoxide, for example, are removed during full activity of the catalyst. In addition, this embodiment of the invention economizes on a heat exchanger.

In another embodiment of the invention, the catalytic process for removing the oxygen is positioned with a downstream heat exchanger after a pre-adsorber and directly before the pressure swing adsorption process. The pre-adsorber removes polymolecular hydrocarbons, which could get deposited on the catalyst material or on the adsorbers of the pressure swing adsorption process. With the existing high pressure of the feed gas, the catalytic process for removing the oxygen can be installed directly before or after the pre-adsorber. Particularly in the case of high pressure and a lack of polymolecular hydrocarbons in the feed gas, the catalytic process for removing the oxygen can be performed directly before the pressure swing adsorption process.

To achieve a very high degree of purity of the separated hydrogen, in another embodiment of the invention the separated hydrogen undergoes another process for catalytically removing residual traces of oxygen. Using a downstream catalytic process for separating oxygen can further increase product purity.

In general, different combinations of the described embodiments of the invention are possible depending upon the oxygen content in the gas mixture and the purity of the hydrogen that is to be achieved. With an oxygen content of less than 1% by volume in the gas mixture, the oxygen content is reduced to less than 200 ppm by the catalytic process for removing the oxygen. With an oxygen content of greater than 1% by volume, the catalytic removal of oxygen from the gas mixture can either take place up to an oxygen content where there is no safety risk for the pressure swing adsorption process (1% by volume) or also to a clearly lower value such as 200 ppm for example. Depending upon the desired product purity or the oxygen content set in the catalytic process, an optional catalytic process for removing the oxygen can then be used after the pressure swing adsorption process.

In terms of the device, the stated objective is attained in that a reactor filled with a solid catalyst is positioned upstream before a device for performing a pressure swing adsorption process.

The catalyst is comprised preferably of a conventional hydrogenating or oxidizing catalyst. The catalyst is preferably comprised of precious metals, in particular platinum and/or palladium, on a solid supporting material, in particular aluminum oxide and/or ceramic in a spherical or honeycomb shape.

The present invention makes it possible in particular to avoid the development of an explosive gas mixture of hydrogen and oxygen in a pressure swing adsorption process thereby minimizing the safety risk.

In the following, the invention shall be explained in greater detail on the basis of comparing an exemplary embodiment of the invention with the prior art.

### BRIEF DESCRIPTION OF THE DRAWINGS

FIG. 1 illustrates a process for separating hydrogen by a pressure swing adsorption process according to the prior art.

FIG. 2 illustrates an exemplary embodiment of a method and system of the present invention.

### DETAILED DESCRIPTION OF THE DRAWINGS

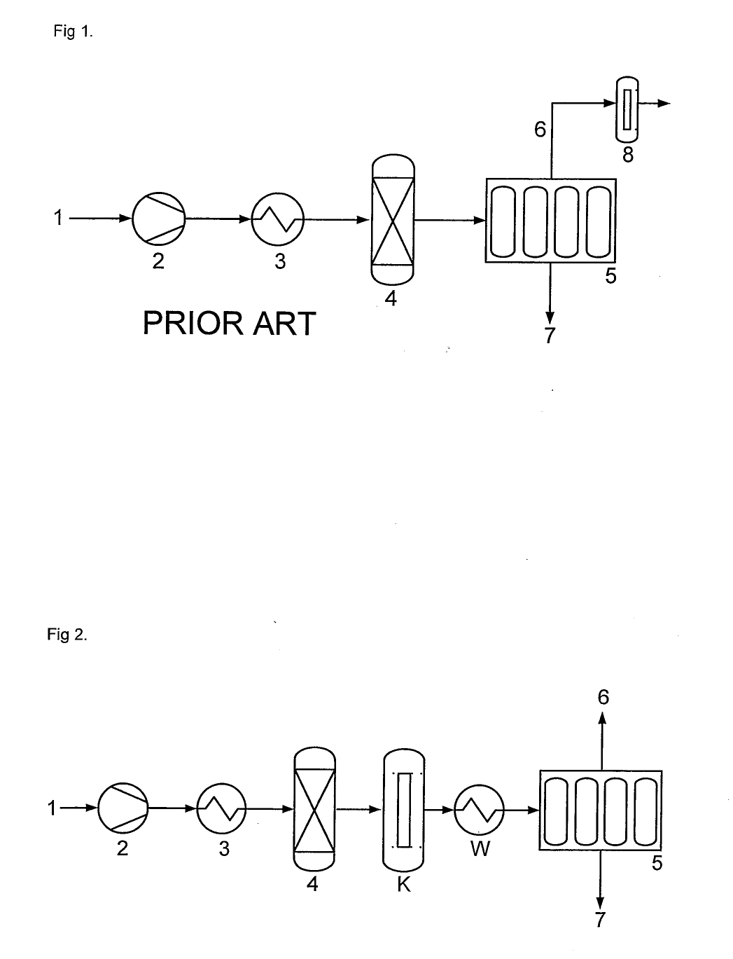

Specifically, FIG. 1 shows a process for separating hydrogen from a gas flow having an oxygen constituent according to the prior art. The gas flow (1) is compressed in a compression process (2) and then cooled to room temperature by means of a heat exchanger (3). The gas flow is fed via a pre-adsorber (4) for separating polymolecular hydrocarbons to a pressure swing adsorption process (5) for separating hydrogen (6) from residual gas (7). In the process according to the prior art, only one gas flow (1) having an oxygen constituent of less than 1% by volume can be processed without a safety risk. To achieve a utilizable product purity of the hydrogen (6), a catalytic process for removing the residual traces of oxygen (8) is connected downstream from the pressure swing adsorption process.

FIG. 2 shows an embodiment of the invention. The gas flow (1) is compressed in a compression process (2) and then cooled to room temperature by means of a heat exchanger (3). After a pre-adsorber (4), the gas flow is fed to a catalytic process to remove oxygen (K). The catalytic reaction for removing the oxygen takes place exothermically. The gas flow is then cooled to room temperature via another heat exchanger (W) and fed to a pressure swing adsorption process (5) for separating hydrogen. The hydrogen (6) is separated there from the residual gas (7). In contrast to the prior art, a gas flow having an oxygen constituent of over 1% by volume can also be processed safely. Through the catalytic process for removing the oxygen (K), the proportion of oxygen in this embodiment of the invention is reduced to less than 200 ppm before the pressure swing adsorption process so that the downstream catalytic removal of residual traces of oxygen can be dispensed with. The separated hydrogen (6) has a utilizable product purity.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for separating hydrogen from a gas flow having an oxygen constituent, the gas flow comprised primarily of hydrogen, nitrogen, oxygen, carbon dioxide, carbon monoxide, methane and/or other hydrocarbons, wherein a catalytic process for removing the oxygen is combined with a pressure swing adsorption process for separating the hydrogen, and wherein the pressure swing adsorption process is performed after the catalytic process for removing the oxygen.

2. The process according to claim 1, wherein gas flows having an oxygen constituent of greater than 1% by volume are processed safely by the pressure swing adsorption process.

3. The process according to claim 1, wherein conventional hydrogenating and oxidizing catalysts are used as catalysts.

4. The process according to claim 1, wherein precious metals, in particular platinum and/or palladium, on a solid supporting material, in particular aluminum oxide and/or ceramic in a spherical or honeycomb shape, are used as catalysts.

5. The process according to claim 1, wherein after the catalytic process for removing the oxygen, the gas flow is fed via a compression process, at least a heat exchanger and/or a pre-adsorber to the pressure swing adsorption process.

6. The process according to claim 1, wherein the hydrogen undergoes a further catalytic process for removing the oxygen after the process for separating the hydrogen.

7. A device for separating hydrogen from a gas flow having an oxygen constituent, the gas flow comprised primarily of hydrogen, nitrogen, oxygen, carbon dioxide, carbon monoxide, methane and/or other hydrocarbons, wherein a reactor filled with a solid catalyst is positioned upstream before a device for performing a pressure swing adsorption process.

8. The device according to claim 7, wherein the catalyst is comprised of a conventional hydrogenating or oxidizing catalyst.

9. The device according to claim 7, wherein the catalyst is comprised of precious metals, in particular platinum and/or palladium, on a solid supporting material, in particular aluminum oxide and/or ceramic in a spherical or honeycomb shape.

10. A method for separating hydrogen from a gas flow having an oxygen constituent, comprising the steps of:
providing the gas flow to a reactor filled with a solid catalyst, wherein the gas flow contains an oxygen content of greater than 1% by volume;
reducing the oxygen content in the gas flow to a content of 200 parts per million or less in the reactor;
providing the reduced oxygen content gas flow to a pressure swing adsorption process; and
removing the hydrogen from the reduced oxygen content gas flow by the pressure swing adsorption process.

11. The method according to claim 10, wherein the hydrogen removed by the pressure swing adsorption process has a utilizable product purity.

12. The method according to claim 11, wherein the hydrogen removed by the pressure swing adsorption process is provided from the pressure swing adsorption process directly to a use of the hydrogen.

13. The method according to claim 10, further comprising the step of cooling the reduced oxygen content gas flow to room temperature in a heat exchanger prior to the step of providing the reduced oxygen content gas flow to the pressure swing adsorption process.

14. The method according to claim 10, wherein the step of reducing the oxygen content in the gas flow to a content of 200 parts per million or less in the reactor prevents a formation of an explosive hydrogen-oxygen gas mixture in the pressure swing adsorption process.

15. The method according to claim 10, wherein the gas flow is coke oven gas.

16. The method according to claim 15, wherein the gas flow additionally includes nitrogen, carbon dioxide, carbon monoxide, methane and/or other hydrocarbons.

17. The method according to claim 12, wherein the use is a process for manufacturing ammonia.

18. The method according to claim 12, wherein the use is as a propellant.

19. The method according to claim 12, wherein the use is in a fuel cell.

20. The method according to claim 10, wherein the catalyst is comprised of a conventional hydrogenating or oxidizing catalyst
